(19) United States
(12) Patent Application Publication
(10) Pub. No.: US 2020/0348055 A1
(43) Pub. Date: Nov. 5, 2020

(54) MAGNETOCALORIC REFRIGERATOR OR HEAT PUMP COMPRISING AN EXTERNALLY ACTIVATABLE THERMAL SWITCH

(71) Applicant: UNIVERSIDADE DO PORTO, Porto (PT)

(72) Inventors: André Miguel TRINDADE PEREIRA, Porto (PT); Joao OLIVEIRA VENTURA, Porto (PT); João Pedro ESTEVES ARAÚJO, Porto (PT); Joel BENTO PUGA, Minde (PT); Daniel José SILVA, Porto (PT); Isabel Alexandra DOMINGUES TARROSO GOMES, Porto (PT); Bernardo Daniel ANTUNES BORDALO, Porto (PT); João Filipe HORTA BELO DA SILVA, Porto (PT); Francisco SALGUEIRO CARPINTEIRO, Barcelos (PT); Joana Cacilda RODRIGUES ESPAIN OLIVEIRA, Porto (PT)

(73) Assignee: Universidade Do Porto, Porto (PT)

(21) Appl. No.: 16/092,304

(22) PCT Filed: Apr. 7, 2017
(86) PCT No.: PCT/IB2017/052006

§ 371 Date: Oct. 9, 2018

(30) Foreign Application Priority Data
Apr. 8, 2016 (PT) 109315

(51) Int. Cl. F25B 21/00; H01H 36/00; F28F 27/00

(52) U.S. Cl. CPC F25B 21/00; H01H 36/00; F28F 2013/008; F25B 2321/0022; F28F 27/00

(57) ABSTRACT

Magnetocaloric refrigerator or heat pump comprising an externally activatable thermal switch for transferring heat from a heat source to a heat sink, comprising: an insulator cage with thermally conductive windows for the source and sink; a magnetic nanofluid, comprised within said cage, wherein said magnetic nanofluid is able to flow under a magnetic field inside the insulator cage between a contact of the thermally conductive window of the heat source and a contact of the thermally conductive window of the heat sink; and a activatable magnet placed at either one of the thermally conductive windows, such that the produced magnetic field is aligned substantially parallel to the temperature gradient from heat source to heat sink. The apparatus alternates between: activating the magnet, such that the nanofluid flows to establish a thermal contact with the thermal source but not with the sink; deactivating the magnet, such that the nanofluid flows to establish a thermal contact with the thermal sink but not with the source.

### TECHNICAL FIELD

The present disclosure relates to the thermal management of devices and systems, specifically to a magnetocaloric refrigerator or heat pump comprising a thermal switch for controlling the heat flux between a heat sink and the heat source, in particular for being used in a magnetic heating and/or cooling apparatus and respective operation methods thereof, particularly as a thermal diode.

### BACKGROUND ART

In order to maintain device operational temperature, at its optimum thermal performance, several technologies have been developed. Vapour chamber, phase change material (PCM) heat sink, synthetic air-jet pump, piezoelectric fan and thermal switches, are some examples of those technologies [1].

Thermal switches present several advantages when compared with the mentioned technologies. They provide a larger range of thermal control, maintain a uniform temperature during oscillation of external thermal conditions, be adopted to pulsed heat addition/rejection systems, and allow localized cooling or heating.

Thermal switches are usually described as a particular kind of thermal diode that has the ability to enable and break the heat flux, allowing the control of the heat flux direction and intensity, between a heat sink and a heat source.

Thermal diodes can be divided in three main categories:
Active solid-state;
Passive solid-state;
Fluidic thermal diodes.

The active solid-state thermal switch category requires an external activation to operate. This is achieved applying a voltage, pressure, magnetic or electric field, etc. Within the active solid-state thermal switches family, thermoelectric and active mechanical contact thermal diodes are the most commonly used and commercially available for room temperature applications. However, thermionic devices can pose as alternative to thermolectrics for high temperature purposes.

The thermoelectric thermal switches of U.S. Pat. No. 1,695,103A, also known as Peltier modules, use the Peltier effect to transfer heat from the hot to the cold junction. Thermoelectrics are well known and wide spread devices. They can be used in several applications as thermal switches, heat valves, refrigerators, heaters or electricity generators (using the associated Seebeck effect). Using a mature technology in its production, thermoelectrics are relatively cheap and provide a fast heat switching. However they present low energy conversion efficiency, making them less attractive for some applications.

Active and passive mechanical contact thermal diodes exploit the intrinsic materials properties. Through the magnetostriction, piezoelectric, thermal expansion-contraction effects, etc it is possible to mechanically establish or break the contact between the hot source and the cold sink, controlling the heat flux. This category is one of the most used in thermal switches, mostly due to the thermo-actuated bimetallic strip (see U.S. Pat. No. 3,617,971A) and shape memory thermal switch (see U.S. Pat. No. 6,239,686 B1). The bimetallic strip thermal switch, is made by joining two metallic strips with different thermal expansion coefficient. Thereby, the strip is forced to bend when a certain temperature is reached, establishing contact between the heat sink and heat source. Shape memory are materials (alloys or polymers) that possess the ability to return to their original form when plastically deformed. The main types of shape-memory alloys are copper-aluminium-nickel, nickel-titanium and the emergent Ni—Mn—Ga. In these alloys, the austenitic-martensitic transitions are responsible for the shape-memory effect. However, glass or melting transitions are the responsible for the shape-memory effect in polymers.

The main disadvantage of the mechanical contact thermal diodes is the thermal contact resistance between the surfaces of the thermal switch device and the heat sink or heat source. The thermal contact resistance of these devices can narrow the operational working speed and cause significant heat losses.

Thermionic devices (see U.S. Pat. No. 4,747,998A), use a voltage potential to force the passage of electrons in a vacuum cavity, localized between a cold anode and a hot cathode. Here, the electrons are considered heat carriers. Despite of their higher efficiency when compared to thermoelectrics, they present a high operating temperature (<230° C.) making them unfit for room temperature applications [2].

Passive solid-state thermal diodes or thermal rectification devices are composed by materials or structures which transfer heat asymmetrically. This means that, for a given temperature difference, the heat rate in one direction through the material/structure is not the same as the heat rate when the temperature difference is reversed. There are several mechanisms at play in the thermal rectification phenomenon, including surface roughness/flatness at material contacts, difference in temperature dependence of thermal conductivity between dissimilar materials at the contact, thermal potential barrier between material contacts, nanostructured asymmetry, anharmonic lattices (typically 1D) and quantum thermal systems. This anisotropic thermal behaviour can be found in graphene and some perovskite cobalt oxides (LaCoO₃ and La_{0.7}Sr_{0.3}CoO₃), as well as in carbon nanotubes and boron nitride nanotubes as patented by Chang et al. (see US 20100167004A1). However at room temperature the reported rectification was of only 2%.

Fluidic thermal diodes are systems that use the properties of fluids to control the flux of heat. Within this category, microfluidic systems have gathered most of the researcher attention and several novel thermal diodes have been developed. Most of these systems use the fluid's motion to manipulate the heat. This can be made using pumps, the effect of gravity or the manipulation of fluids properties through an external activation. Exploiting this feature there are three main ways to put fluids in motion: through the appliance of an electric field, the appliance of a magnetic field and through the simultaneous appliance of electric and magnetic fields.

In example examining FIG. 1, it is possible to understand that by applying an electrostatic potential between the electrode 11 and a drop of fluid electrolyte 12 one can change its wetting angle (θ) establishing or braking the contact between the heat sink and the heat source 21, as demonstrated in FIG. 2 [2].

Magnetic nanofluids (MNF) also known as ferrofluids offer the possibility to control and promote the fluid flow and consequently the heat transfer process, through the appliance of an external magnetic field. MNF are colloidal mixtures of ferromagnetic (i.e. iron, nickel, cobalt) or ferrimagnetic (Fe₂O₃, Fe₃O₄, CoFe₂O₄) nanoparticles dispersed in water, ethylene glycol (EG), and/or various types of oils [3]. To prevent the aggregation caused by London-van der Waals or magnetic dipole-dipole interactions, the suspended solid particles can be coated with a surfactant layer i.e. oleic acid, tetramethylammonium hydroxide [4,5]. As conventional NFs, the properties of MNFs can be engineered thought the manipulation of their composition. Therefore, their properties (i.e. viscosity, thermal conductivity, thermal energy storage capacity, heat transfer coefficients, etc.) can be tailored to meet the specific requirements of the intended application.

Several devices using MNFs were developed to control the heat flux, as the Heat Pipe Technologies presented in documents JPH11183066A and U.S. Pat. No. 5,005,639A. These proposals exploited the magnetic induced flow properties of ferrofluids, where the appliance of the magnetic field to the MNF has the only purpose of putting in a continuous motion the fluid (instead of a mechanic fluid pump), getting it close to the heat source and evacuating the heat close to the heat exchanger.

In document JP2012233627, the heat transport is achieved using a non-magnetic solid floating or sinking in a magnetic fluid. In this case, a bulk material (BM), is the heat carrier and establishes the thermal contact between the hot and cold sides, while the magnetic fluid acts as the bulk material carrier, forcing its movement inside a container.

These facts are disclosed in order to illustrate the technical problem addressed by the present disclosure.

### REFERENCES

[1]—S. H. Jeong, S. K. Nam, W. Nakayama, S. K. Lee. New. design of a liquid bridge heat switch to ensure repetitive operation during changes in thermal conditions. Applied Thermal Engineering 59 (2013) 283-289.
[2] Yeom J, Shannon M A. Comprehensive microsystems. New York: Elsevier; 2007.
[3]—I. Nkurikiyimfura, Y. Wang, Z. Pan. Heat transfer enhancement by magnetic nanofluids—A review. Renewable and Sustainable Energy Reviews 21 (2013) 548-561
[4]—Li D, Jiang D, Chen M, Xie J. An easy fabrication of monodisperse oleic acid coated Fe3O4 nanoparticles. Materials Letters 64 (2010) 2462-4. [5]—N. Bayat, A. Nethe, J. M. Guldbakke, J. Hesselbach, V. A. Naletova, H-D Stahlmann, et al. Technical applications. In: Odenbach S, editor. Colloidal Magnetic Fluids: Basics, Development and Application of Ferrofluids. Berlin, Heidelberg: Springer-Verlag; 2009.
[6]—Su-Heon Jeong, Sung-Ki Nam, Wataru Nakayama and Sun-Kyu Lee. New design of a liquid bridge heat switch to ensure repetitive operation during changes in thermal conditions. Applied Thermal Engineering 59 (2013) 283-289.
[7]—J. Philip, P. D. Shima and B. Raj. Evidence for enhanced thermal conduction through percolating structures in nanofluids. Nanotechnology 19(2008) 305706.
[8]—L. Qiang, X. Yimin, J. Wang. Experimental investigations on transport properties of magnetic fluids. Experimental Thermal and Fluid Science 30 (2005) 109-116.

### General Description

It is disclosed an externally activated thermal switch (herewith, EATS), which is a device that has the purpose to control the heat flux between a heat sink and a heat source. An embodiment comprises a thermally insulator cage, open in the top and in the bottom, allowing the sequential contact of the thermal bridge or thermal carrier with the two sides. The thermal bridge, or thermal carrier, is sealed inside the insulator cage with a heat conductor plate. Interrupting (OFF mode) and establishing (ON mode) contact with the heat sink and source, it is possible to control the flux of heat through it. The embodiments of the present disclosure offer the capability to work with a vast number and nature of thermal bridges (TB) and thermal carriers (TC), as well as with different nature of external activations, such as magnetic, allowing it to be used in a wide range of operating conditions.

In the embodiments of the present disclosure, we make use of two operating principles different from the above mentioned:
The MNF thermal conductivity enhancement under a magnetic field. When the magnetic field is parallel to the temperature gradient, nanoparticle chains are formed, inside the MNF, along the direction of temperature gradient, allowing a more effective energy transport. Such phenomenon of thermal conductivity enhancement of MNFs can be manipulated with the intensity and direction of the applied magnetic field;
The so called ferrofluid thermal contact switch. Here, an external magnetic field is applied to force the entire MNF, or portion of it, to migrate from the heat source to the heat sink and vice-versa. Therefore the contact between these two places is alternately interrupted and the heat is transported using mainly the heat capacity of the MNF (suspended nanoparticles and suspending fluid).

Compared to Heat Pipe technologies, the presently disclosed EATS geometry can provide a large improvement in the heat transport efficiency, this effect is can be substantiated by the enhancement of the MNF thermal conductivity as explained by Philip et al. [7]. It was observed that, when an external magnetic field is applied, parallel to the temperature gradient, the MNF thermal conductivity (k) is enhanced up to 300%, corresponding to a thermal conductivity ratio (k/kf) of 4, where k and kf are the thermal conductivities of the nanofluid and the base fluid, respectively. This is evidence that the potential use of this phenomenon in thermal switches has a significant effect. The k enhancement was attributed to uniformly dispersed chain-line aggregates of nanoparticles formed under the influence of the magnetic field. Inversely, the decrease in k is expected to be due to the zippering of these chains. Moreover, these observations showed that the clusters morphology and distribution have a strong effect in the effective transport of heat through percolating interfacial structures, since they play an important role in the fluid convection velocity and heat conduction.

Regarding document JP2012233627A, the presently disclosed EATS eliminates the use of the BM and improves the thermal contact at the hot and cold side, since the thermal resistance in the interface between the two solid surfaces is much higher than between a liquid-solid interface [6]. This allows EATS to increase the working frequencies and potentially its efficiency.

The present disclosure (in particular, the EATS embodiments) provides an apparatus and method for performing heat switching between heat source and heat sink. As depicted in FIG. 3, the device has two operating modes ON and OFF. In the OFF mode no external magnetic field is applied. Therefore, the thermal bridge or thermal carrier will remain in the steady state in the bottom of the insulator cage. In this way no connection between the top and bottom plates is established, avoiding the heat flux between them. When an external magnetic field is applied (ON mode), the thermal bridge (TB) or thermal carrier (TC) will be attracted from the bottom of the insulator cage up to the surface, establishing a thermal bridge between the top and bottom plates that enables the flux of heat.

With a simple design, this system has the potential to be downsized to the micro scale. The capability to work with a vast number and nature of thermal bridges and thermal carriers, allows this equipment to be used in a wide range of operating conditions. The EATS can also be applied in different configurations, e.g. series, parallel or tubular. Copulating these devices in series (i.e. the source of a first switch connected directly or indirectly with the sink of a second switch) may increase the operating efficiency. By installing this device in parallel (i.e. the source of a first switch connected, directly or indirectly, with the source of a second switch, and the sink of a first switch, connected directly, or indirectly with the sink of a second switch) it is possible to cover bigger areas and to independently establish the thermal contact between the heat sources and eat sink, allowing localized cooling to be performed.

For applications were the EATS needs to work in the horizontal or in the absence of gravity, the OFF state can also be achieved applying an external magnetic field to attract the TB or TC. For example, alternating the appliance of a magnetic field on the two sides of the EATS device, can force the movement of the TB or TC and therefore overcome the misdirected gravity (in relation to the device needs) or its absence.

Therefore, the presented externally activated thermal switch can represent a versatile, reliable and inexpensive device to control heat fluxes. Besides of the above mentioned advantages, this invention also offers the possibility to use small particles or bulk magnetocaloric materials (e.g. Gd), allowing the synchronization of magnetization/demagnetization cycles with the contact with the cold reservoir/heat sink, the principle of a magnetocaloric refrigerator/heat pump.

It is described an externally activatable thermal switch for transferring heat from a heat source to a heat sink, said switch comprising:
an insulator cage with thermally conductive windows for the heat source and for the heat sink;
a magnetic nanofluid, comprised within said insulator cage,
wherein said magnetic nanofluid is able to flow under a magnetic field inside the insulator cage between a contact of the thermally conductive window of the heat source and a contact of the thermally conductive window of the heat sink; and
a first activatable magnet placed at either one of the thermally conductive windows, such that the produced magnetic field is aligned substantially parallel to the temperature gradient from heat source to heat sink.

It is disclosed a magnetocaloric refrigerator or heat pump, comprising an externally activatable thermal switch as described.

In an embodiment of the magnetocaloric apparatus, the activatable thermal switch is arranged such that, when the thermal switch is activated, the apparatus alternates between the following two states:
activating the first activatable magnet, such that the magnetic nanofluid flows to establish a thermal contact with the thermal source and not with the thermal sink;
deactivating the first activatable magnet, such that the magnetic nanofluid flows to establish a thermal contact with the thermal sink and not with the thermal source, and, optionally, activating the second activatable magnet.

An embodiment of the magnetocaloric apparatus comprises an electronic circuit or electronic controller configured to alternate the apparatus between the following two states when the thermal switch is activated:
activating the first activatable magnet, such that the magnetic nanofluid flows to establish a thermal contact with the thermal source and not with the thermal sink;
deactivating the first activatable magnet, such that the magnetic nanofluid flows to establish a thermal contact with the thermal sink and not with the thermal source, and, optionally, activating the second activatable magnet.

It is to be noted that if the material of the heat source or of the heat sink is fluid-tight (e.g. not porous), the thermally conductive windows which are part of the insulator cage can be simply holes in the insulator cage. Otherwise, they can be fluid-tight material which is suitably able to conduct heat.

In a embodiment, the first activatable magnet is an electromagnet.

In a embodiment, the first activatable magnet is a permanent magnet movable between two positions in respect of its thermally conductive window: a proximal position and a distal position.

In a embodiment, the magnetic nanofluid is a colloidal mixture of ferromagnetic nanoparticles, further in particular of iron, nickel, or cobalt nanoparticles, or is a ferromagnetic nanoparticle dispersion, further in particular of Maghemite (Fe2O3), Magnetite (Fe3O4) or Cobalt Ferrite (CoFe2O4) nanoparticles, or more generally Iron oxides (Fe2O3 or Fe3O4) or Cobalt Ferrite (CoFe2O4).

An embodiment further comprises a second activatable magnet, placed at the other of the thermally conductive windows in respect of the thermally conductive window of the first activatable magnet, such that the produced magnetic field is aligned substantially parallel to the temperature gradient from heat source to heat sink.

In a embodiment, the second activatable magnet is an electromagnet.

In a embodiment, the second activatable magnet is a permanent magnet movable between two positions in respect of its thermally conductive window: a proximal position and a distal position.

In a embodiment, the insulator cage is tubular.

In a embodiment, the insulator cage is made of a polymer, ceramic or any other material suitable to limit the thermal contact between the two windows of the thermal switch.

In a embodiment, the thermally conductive windows are made of a thermally conductive or thermally semi-conductive material, metal, alloy, ceramic or composite.

It is also described a magnetic thermal, namely magnetocaloric, apparatus comprising a plurality of the externally activatable thermal switches according to any of the previous embodiments, wherein said switches are connected in series, parallel, or combinations thereof.

It is also described a magnetic thermal, namely magnetocaloric, apparatus comprising one or more of the externally activatable thermal switches according to any of the previous embodiments, for thermal energy storage, for refrigeration or for heating, or combinations thereof.

It is also described a magnetic thermal, namely magnetocaloric, apparatus comprising an externally activatable thermal switch according to any of the previous embodiments, layered between two magneto caloric material layers.

It is also described a magnetic thermal, namely magnetocaloric, apparatus comprising a plurality of the externally activatable thermal switches according to any of the previous embodiments, layered in alternating layers with a magneto caloric material layer.

It is also disclosed a method for operating the magnetocaloric apparatus comprising an externally activatable thermal switch according to any of the previous embodiments, said method comprising:
activating the first activatable magnet, such that the magnetic nanofluid flows to establish a thermal bridge between heat source and heat sink, when the switch is activated;
deactivating the first activatable magnet, such that the magnetic nanofluid flows to disrupt a thermal bridge between heat source and heat sink, when the switch is deactivated.

It is also disclosed a method for operating the magnetocaloric apparatus comprising an externally activatable thermal switch according to any of the previous embodiments, said method comprising, when the switch is activated, alternating between the following two states:
activating the first activatable magnet, such that the magnetic nanofluid flows to establish a thermal contact with the thermal source and not with the thermal sink;
deactivating the first activatable magnet, and optionally activating the second activatable magnet, such that the magnetic nanofluid flows to establish a thermal contact with the thermal sink and not with the thermal source.

In an embodiment, the frequency of the alternating between the two states is between 5 and 30 Hz, further in particular between 10 and 20 Hz, or between 5 and 20 Hz, or between 10 and 30 Hz.

In an embodiment, an external predefined level of electric current, electric field, pressure or light is used to trigger the externally activatable thermal switch.

It is also described a magnetic thermal, namely magnetocaloric, apparatus according to any of the previous embodiments, comprising an electronic circuit or electronic controller configured to carry out the method of any of the previous method embodiments.

It is also described a non-transitory storage media including computer program instructions for implementing a magnetic thermal, namely magnetocaloric, apparatus, the program instructions including instructions executable to carry out the method of any of the previous method embodiments.

### BRIEF DESCRIPTION OF THE DRAWINGS

The following figures provide preferred embodiments for illustrating the description and should not be seen as limiting the scope of invention.

FIG. 1: Schematic representation of a liquid wettability tuning through the application of an electric voltage.

FIG. 2: Schematic representation of contact control between two surfaces through the tuning of a drop wettability.

FIG. 3: Schematic representation of the front view of an embodiment of the externally activated thermal switch and respective illustration the working method using a fluid of flexible material or metallic fillings as thermal bridge or thermal carrier;

FIG. 4: Schematic representation of 3D representation of an embodiment of the externally activated thermal switch structure;

FIG. 5: Schematic representation of front view of an embodiment of the externally activated thermal switch and respective illustration of the working method using a solid as thermal bridge or thermal carrier;

FIG. 6: Schematic representation of an embodiment of the apparatus used to prove the externally activated thermal switch concept.

FIG. 7: Schematic representation of an embodiment of the apparatus having a cascade of magneto caloric material and a thermal switch.

### DETAILED DESCRIPTION

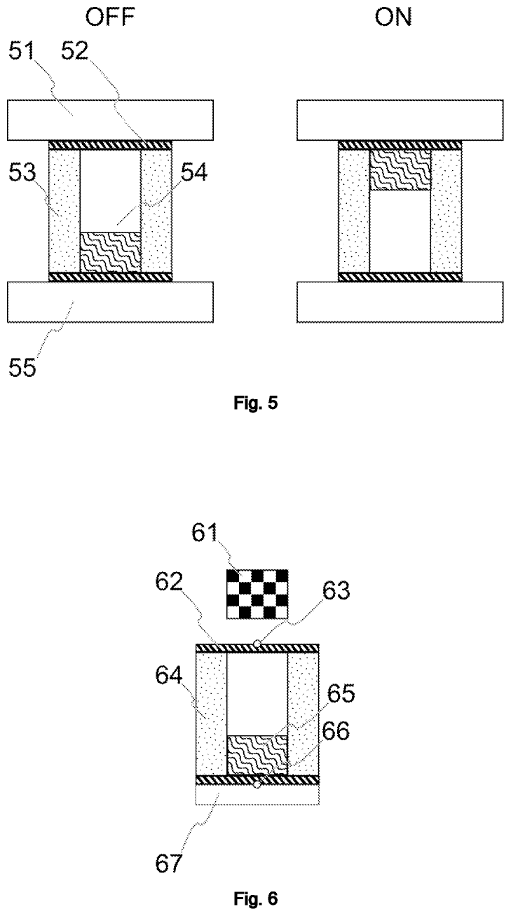

With reference to the drawings and more specifically FIG. 5, the externally activated thermal switch (EATS) is represented and associated to the heat sink 51 and heat source 35. The EATS structure is comprised by a 3×3×3 cm (FIG. 6) Poly(methyl methacrylate) (PMMA) thermal insulator cage 53, with a transversal cavity with 1.5 cm diameter and 3 cm of height 61. In the top and bottom two sheets of copper 52 are fixed to the PMMA body using a polyurethane (PU) based glue.

The interior of the PMMA thermal insulator, contains magnetic nanofluid (MNF) 54. The MNF used is a colloidal mixtures of 4.35 vol. % of 10 nm Fe₃O₄ nanoparticles dispersed in poly-α-olefin oil.

The present device uses a permanent magnet 61 to apply a magnetic field to the MNF 65, as depicted in FIG. 6. In this way the magnetic field is aligned parallel to the temperature gradient. This mechanism allows the enhancement of the MNF thermal conductivity up to 300% when compared to the systems where the magnetic field is applied perpendicular to the temperature gradient, as demonstrated in [7,8].

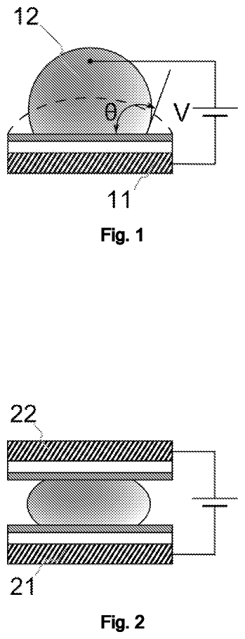

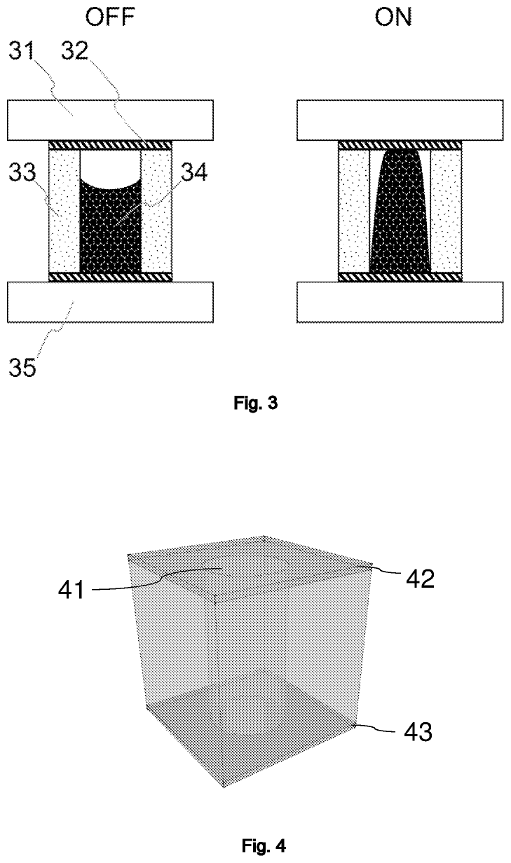

Adjusting the quantity of the MNF inside the insulator cage and the magnetic field, it is possible to have two different mechanisms of thermal transport:
1—The fluid is pulled by the magnetic field to form a bridge between the heat source and the heat sink (FIG. 1).
2—The fluid is pulled from the heat source and migrates to the heat sink interrupting the previous contact with the heat source (FIG. 5).

These two mechanisms are following described for further understanding.
1—When an external magnetic field is applied using a permanent magnet 61 the MNF is attracted to the top in the direction of the permanent magnet. Therefore, the MNF establishes a thermal bridge between the heat sink 51 and the heat source 35. The nanoparticles contained in the MNF are forced to travel inside the nanofluid, transporting heat through the fluid and injecting it into the top copper sheet 52 that then conducts to the heat sink. After losing heat to the heat sink, the magnetic field is removed or reversed and the already cooled MNF travels down in the direction of the heat source, reinitiating the process.
2—If the magnetic field felt by the MNF is sufficiently strong, it will be totally pulled from the bottom (heat source) to the top (heat sink). In this case, we have no longer the formation of a thermal bridge and the system will behave as a “ferrofluid thermal contact switch”.

To assess the performance of the present invention the apparatus schematized in FIG. 6 was put into place. Here the EATS 64 containing the MNF 65 was attached to a Peltier element 67 (heat source). In each side of the EATS and in contact to the copper sheets 62 a thermocouple was fixed 63 and 66, in order to record the changes in temperature. Using a permanent magnet 61, the magnetic field was alternately applied and removed. It was found that our device, using the “ferrofluid thermal contact switch” mechanism, can operate between 5 and 20 Hz, reducing the span temperature between the hot and cold sides in ^{˜}70%.

By decreasing the thermal switch thickness to 1 cm, it was possible to increase the device operational frequency, with no loss of efficiency. Therefore, it was assessed a reduction in the temperature span of ^{˜}80% for frequencies of 5 Hz and ^{˜}70% for frequencies between 10-30 Hz.

Using the apparatus described above (FIG. 6), we tested the substitution of the MNF for an iron disk with 1.5 cm of diameter and 1 mm of thickness. The results showed a reduction (in comparison with the MNF case) in the temperature span between the two sides (hot and cold) in 56%. This experiment attests the versatility of the presented thermal switch and the capability to work with other filling materials, rather than MNF, allowing it to be tailored for a specific application.

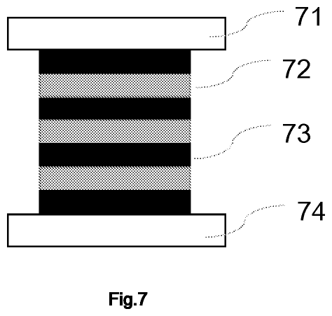

FIG. 7 illustrates a representation of of an embodiment of the apparatus having a cascade of magneto caloric material and a thermal switch, where the following are represented: 71—Heat sink; 72—Magneto caloric material (MCM); 73—Thermal switch; 74—Heat source.

While specific embodiments of this invention have been shown and described, it should be understood that many variations thereof are possible. The description of the present invention has been presented for purposes of illustration and description, and is not intended to be exhaustive or limited to the invention in the form released. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

The term “comprising” whenever used in this document is intended to indicate the presence of stated features, integers, steps, components, but not to preclude the presence or addition of one or more other features, integers, steps, components or groups thereof.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

It is to be appreciated that certain embodiments of the invention as described herein may be incorporated as code (e.g., a software algorithm or program) residing in firmware and/or on computer useable medium having control logic for enabling execution on a computer system having a computer processor, such as any of the servers described herein. Such a computer system typically includes memory storage configured to provide output from execution of the code which configures a processor in accordance with the execution. The code can be arranged as firmware or software, and can be organized as a set of modules, including the various modules and algorithms described herein, such as discrete code modules, function calls, procedure calls or objects in an object-oriented programming environment. If implemented using modules, the code can comprise a single module or a plurality of modules that operate in cooperation with one another to configure the machine in which it is executed to perform the associated functions, as described herein.

The disclosure should not be seen in any way restricted to the embodiments described and a person with ordinary skill in the art will foresee many possibilities to modifications thereof.

The above described embodiments are combinable.

The following claims further set out particular embodiments of the disclosure.

1. A magnetocaloric refrigerator or heat pump apparatus, comprising an externally activatable thermal switch for transferring heat from a heat source to a heat sink, said switch comprising:
an insulator cage having thermally conductive windows having a contact to the heat source and a contact to the heat sink;
a magnetic nanofluid within said insulator cage,
wherein said magnetic nanofluid flows under a magnetic field inside the insulator cage between the contact of the thermally conductive window to the heat source and the contact of the thermally conductive window to the heat sink; and
a first activatable magnet placed at either one of the thermally conductive windows, such that the magnetic field produced by the magnet is aligned substantially parallel to a temperature gradient from heat source to heat sink.

2. The magnetocaloric apparatus according to claim 1, wherein the activatable thermal switch is arranged such that, when the activatable thermal switch is activated, the apparatus alternates between the following two states:
activating the first activatable magnet, such that the magnetic nanofluid flows to establish a thermal contact with the thermal source and not with the thermal sink; and
deactivating the first activatable magnet, such that the magnetic nanofluid flows to establish a thermal contact with the thermal sink and not with the thermal source.

3. The magnetocaloric apparatus according to claim 2, wherein the activatable thermal switch is arranged such that a frequency of the alternating between the two states is between 5 and 30 Hz.

4. The magnetocaloric apparatus according to claim 1, wherein the magnetic nanofluid is a colloidal mixture of ferromagnetic nanoparticles or is a ferromagnetic nanoparticle dispersion.

5. The magnetocaloric apparatus according to claim 4, wherein the first activatable magnet is an electromagnet.

6. The magnetocaloric apparatus according to claim 1, wherein the first activatable magnet is a permanent magnet movable between a proximal position and a distal position in respect of its thermally conductive window.

7. The magnetocaloric apparatus according to claim 1, further comprising a second activatable magnet, placed at the other of the thermally conductive windows in respect of the thermally conductive window of the first activatable magnet, such that the produced magnetic field is aligned substantially parallel to the temperature gradient from heat source to heat sink.

8. The magnetocaloric apparatus according to claim 7, wherein the second activatable magnet is an electromagnet.

9. The magnetocaloric apparatus according to claim 7, wherein the second activatable magnet is a permanent magnet movable between a proximal position and a distal position in respect of its thermally conductive window.

10. The magnetocaloric apparatus according to claim 1, wherein the insulator cage is tubular.

11. The magnetocaloric apparatus according to claim 1, wherein the insulator cage is made of a polymer, a ceramic or another material that limits thermal contact between the two windows of the thermal switch.

12. The magnetocaloric apparatus according to claim 1, wherein the thermally conductive windows are made of a thermally conductive or thermally semi-conductive material, metal, alloy, ceramic or composite.

13. The magnetocaloric apparatus according to claim 1, further comprising a plurality of the externally activatable thermal switches, wherein said switches are connected in series, parallel, or in combinations thereof.

14. The magnetocaloric apparatus according to claim 1, wherein there are one or more of said externally activatable thermal switches, and wherein said one or more of the externally activatable thermal switches is configured for thermal energy storage, for refrigeration, for heating, or for combinations thereof.

15. The magnetocaloric apparatus of claim 1, further comprising two magnetocaloric material layers, wherein the externally activatable thermal switch is a layer between the two magnetocaloric material layers.

16. The magnetocaloric apparatus of claim 1, further comprising a plurality of the externally activatable thermal switches and a plurality of magnetocaloric material layers arranged in alternating layers.

17. A method for operating a magnetocaloric apparatus of the type comprising an externally activatable thermal switch for transferring heat from a heat source to a heat sink, wherein the switch comprises:
an insulator cage having thermally conductive windows having a contact to the heat source and a contact to the heat sink;
a magnetic nanofluid within said insulator cage; and
a first activatable magnet placed at either one of the thermally conductive windows,
the method comprising the steps of:
activating the first activatable magnet, such that the magnetic nanofluid flows to establish a thermal bridge between heat source and heat sink, when the switch is activated;
deactivating the first activatable magnet, such that the magnetic nanofluid flows to disrupt a thermal bridge between heat source and heat sink, when the switch is deactivated.

18. The method for operating the externally activatable thermal switch according to claim 17, comprising the step of alternating between the following two states when the switch is activated:
activating the first activatable magnet, such that the magnetic nanofluid flows to establish a thermal contact with the thermal source and not with the thermal sink; and
deactivating the first activatable magnet such that the magnetic nanofluid flows to establish a thermal contact with the thermal sink and not with the thermal source.

19. The method according to claim 17, wherein a frequency of the alternating between the two states is between 5 and 30 Hz.

20. The method according to claim 17, wherein a predefined level of electric current, electric field, pressure or light is used to trigger the externally activatable thermal switch.

21. The method of claim 17, further comprising the step of providing an electronic circuit or electronic controller which includes the magnetocaloric apparatus.

22. A non-transitory storage media including computer program instructions for implementing a magnetic thermal apparatus, the program instructions including instructions executable to carry out the method of claim 17.
